(19) United States
(12) Patent Application Publication
(10) Pub. No.: US 2005/0031328 A1
(43) Pub. Date: Feb. 10, 2005

(54) Lens control apparatus of a digital still camera

(76) Inventors: Shih-Lung Weng, Sanmin Chiu (TW); Ming-Chih Yuan, Jhongli City (TW)

Correspondence Address: RABIN & BERDO, P.C., Suite 500, 1101 14th Street, N.W., Washington, DC, 20005, US

(21) Appl. No.: 10/911,550

(22) Filed: Aug. 5, 2004

(30) Foreign Application Priority Data
Aug. 8, 2003 (TW) 92121934

(51) Int. Cl. G03B 17/00

(52) U.S. Cl. 396/85

(57) ABSTRACT

A lens control apparatus includes a lens and an electromagnetic switch, wherein the lens is rotatably coupled to a casing of a digital still camera, while the electromagnetic includes a permanent magnet and an electromagnet. The permanent magnet projects from the periphery of the lens, while the electromagnet is disposed on the casing of the digital still camera. When the electromagnet switch turns on, a magnetic force is produced to rotate the lens relative to the digital still camera so that a two- or multiple-level zooming can thus be achieved.

This application claims the benefit of Taiwan application Serial No. 92121934, filed Aug. 8, 2003, the subject matter of which is incorporated herein by reference.

### BACKGROUND OF THE INVENTION

1. Field of the Invention

The invention relates in general to a lens control apparatus, and more particularly to a lens control apparatus of a digital still camera.

2. Description of the Related Art

Due to prompt and instant image processing abilities, digital still camera has already gained a great popularity. With the feature of instant availability, i.e. a picture can be seen immediately after it was taken, digital still camera is experiencing a strong growth in market demand, bringing about continual improvement and breakthrough in terms of functions and accessory equipment.

Digital still cameras with two-level zooming function are already available in the market. The so-called “two-level” zooming” refers to the adjustment of focal length via the zooming in or zooming out of the lens when taking a close or a remote shot. While the focal magnification of a digital still camera is determined by the focal length setting of the lens, the solution and quality of the picture taken after zooming still remains the same.

The zoom setting of a digital still camera is achieved via the zooming of the lens; thereby controlling the focal length. The zooming of the lens is achieved via rotation. Currently the rotation of the lens can either be powered by a motor or achieved by manual operation.

Compared with a conventional camera, a digital still camera can be much smaller in size and enjoy more freedom in terms of outlook design because no film is required. For a digital still camera which is small in size, a motor which would occupy a large volume of space is indeed not an appropriate choice for the rotation of the lens. However, if a manual operation mechanism is adopted, not only inconvenience in operation would arise, the digital still camera would even look less valuable and lower-ranked.

### SUMMARY OF THE INVENTION

It is therefore an object of the invention to provide a lens control apparatus, which, by means of a simple mechanism, actuates the zooming function of the lens and drives the lens to rotate so as to easily achieve two- or multi-level zooming.

The invention achieves the above-identified object by providing a lens control apparatus comprising a lens and an electromagnetic switch. The lens is rotatably coupled to the digital still camera, while the electromagnetic switch includes a permanent magnet and an electromagnet. The permanent magnet projects from the periphery of the lens, while the electromagnet is disposed on the casing of the digital still camera. When the electromagnet switch turns on, the magnetic force produced by the permanent magnet and the electromagnet will drive the lens to rotate relative to the digital still camera.

The invention achieves the above-identified object by further providing a lens control apparatus comprising a lens and an electromagnetic switch. The lens is rotatably coupled to the digital still camera, while the electromagnetic switch includes a permanent magnet, a first electromagnet and a second electromagnet. The permanent magnet projects from the periphery of the lens, while the first electromagnet and the second electromagnet which are disposed on the casing of the digital still camera are situated at different angles to the lens. When the electromagnet switch turns on, the magnetic force produced by the permanent magnet and either one of the first magnet and the second magnet will drive the lens to rotate to different angles relative to the digital still camera.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a schematic diagram of a digital still camera with zooming function;

FIGS. 2A to 2B shows the movements of the lens control apparatus of a digital still camera according to a first embodiment of the invention;

FIGS. 3A to 3B shows the movements of the lens control apparatus of a digital still camera according to a second embodiment of the invention; and

FIGS. 4A to 4D shows the movements of the lens control apparatus of a digital still camera according to a third embodiment of the invention.

### DETAILED DESCRIPTION OF THE INVENTION

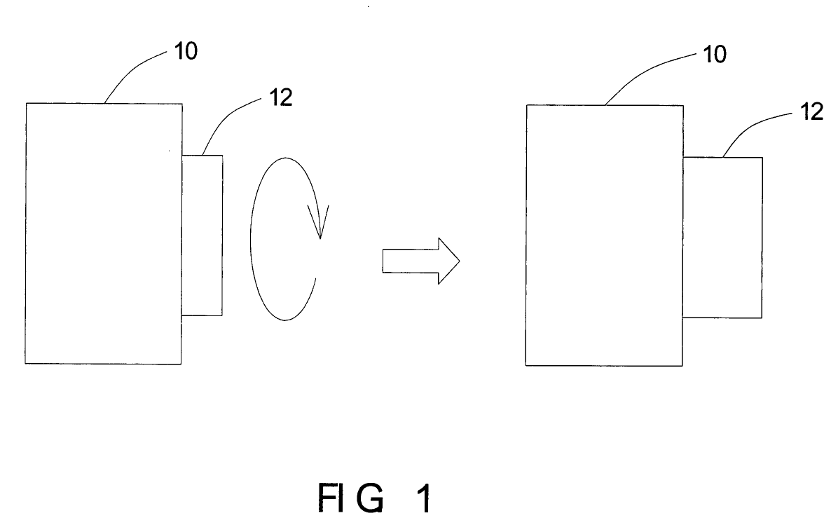

Referring first to FIG. 1, a schematic diagram of a digital still camera with zooming function. Digital still camera 10 achieves the zoom setting of lens 12 via the zooming of the lens 12, wherein the lens 12 is rotatable when adjusting the focal length.

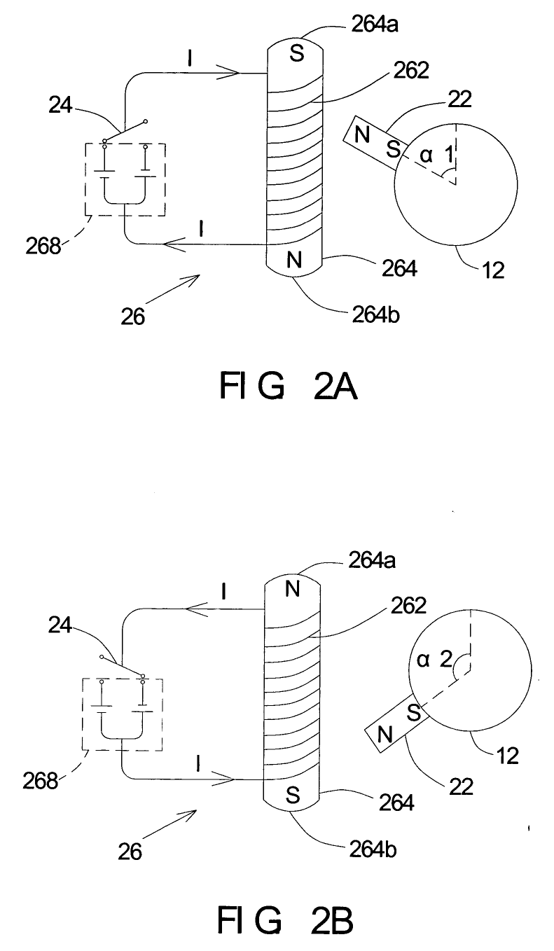

The lens control apparatus according to the invention includes a lens and an electromagnetic switch. The rotation of the lens is powered by a magnetic force produced by the electromagnetic switch to actuate the zooming function of the lens of the digital still camera. In FIG. 1, lens 12 is rotatably coupled onto the casing of digital still camera 10. Referring to FIGS. 2A to 2B, diagrams show the movements of the lens control apparatus of a digital still camera according to a first preferred embodiment of the invention. The electromagnetic switch of the lens control apparatus as shown in FIG. 2A to FIG. 2B includes a permanent magnet 22 and an electromagnet 26. The permanent magnet 22 projects from the periphery of the lens 12 while the electromagnet 26 is disposed on the casing of the digital still camera 10. When the electromagnetic switch turns on, the permanent magnet 22 and the electromagnet 26 will produce a magnetic force driving the lens 12 to rotate relative to the digital still camera 10. The electromagnetic switch includes a switching element 24, which is coupled to the electromagnet 26 for converting the polarity thereof.

The electromagnet as shown in FIGS. 2A to 2B further includes an iron rod 264, a coil 262, and a power source 268. The iron rod 264, which is illustrated by example of a straight iron bar, has a first end 264a and a second end 264b with a coil 262 winding around iron bar 264. The power source 268 provides current I to the coil 262 and defines a first magnetic pole and a second magnetic pole at the first end 264a and the second end 264b respectively. The switching element 24 is for switching the flow of current so as to change the polarity of the electromagnet 26 and redefine the polarity thereof.

In FIG. 2A, current I flows from the first end 264a to the second end 264b in a clockwise direction via the coil 262. Therefore, an S-polarity is formed at the first end 264a and is defined as the first magnetic pole, while an N-polarity is formed at the second end 264b and is defined as the second magnetic pole. As shown in FIG. 2A, since the permanent magnet 22 projects its N-polarity end on the periphery of the lens 12, a mutual attraction produced by opposite polarities, i.e. the N-polarity of the permanent magnet 22 and the S-polarity of the first end 264a of the iron rod 264, will drive the permanent magnet 22 to rotate towards the first end 264a. On the contrary, if the permanent magnet 22 projects its S-polarity end on the periphery of the lens 12, a mutual attraction produced by opposite polarities, i.e. the S-polarity of the permanent magnet 22 and the N-polarity of the second end 264b of the iron rod 264, will drive the permanent magnet 22 to rotate towards the second end 264b.

In the first preferred embodiment, the lens control apparatus adopts a singly-coil-dual-power module. The coil 262 is a single coil, but the power source 268 is a dual power set which is able to provide coil 262 with two currents of opposite directions. In FIG. 2B, the switching element 24 switches the current directions, causing the current to flow anti-clockwise from the second end 264b to the first end 264a. An N-polarity is formed at the first end 264a and is defined as the second magnetic pole, while an S-polarity is formed at the second end 264b and is defined as the first magnetic pole. Since the permanent magnet 22 projects its N-polarity end on the periphery of the lens 12, the mutual attraction produced by the N-polarity of the permanent magnet 22 and the S-polarity of the second end 264b will drive the lens 12 to rotate towards the second end 264b. On the contrary, if the permanent magnet 22 projects its S-polarity end on the periphery of the lens 12, the mutual attraction produced by the S-polarity of the permanent magnet 22 and the N-polarity of the first end 264a will drive the lens 12 to rotate towards the first end 264a.

The lens control apparatus according the first preferred embodiment controls the direction of the current by switching a dual power set so as to form an electromagnetic switch with two opposite polarities. The permanent magnet 22 can then either drive the lens 12 to rotate a1 degrees relative to the digital still camera to be positioned at the first end 264a or drive the lens 12 to rotate a2 degrees relative to the digital still camera to be positioned at the second end 264b, so that the lens 12 can be zoomed in or zoomed out to adjust the focal length. A two-level zooming is thus achieved accordingly.

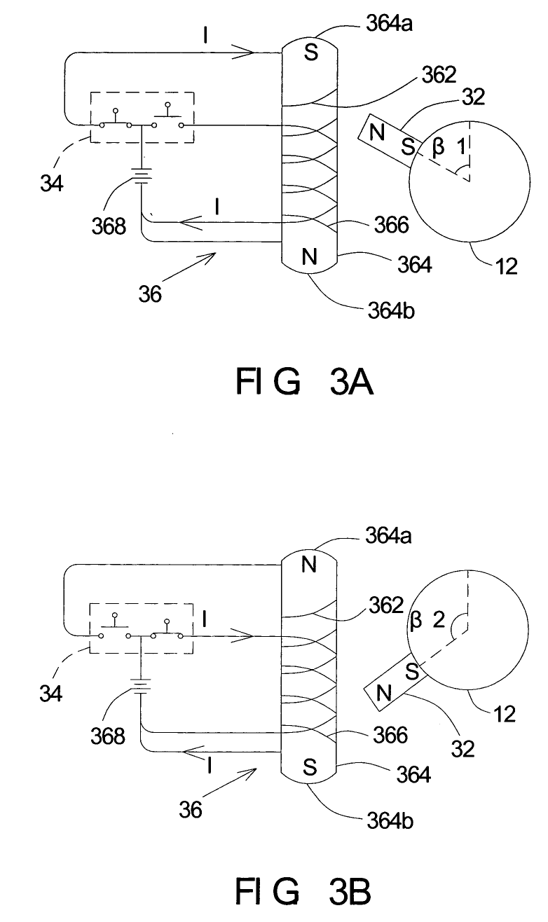

FIGS. 3A to 3B show the movements of the lens control apparatus of a digital still camera according to a second embodiment of the invention. The electromagnetic switch of the lens control apparatus as shown in FIG. 3A to FIG. 3B includes a permanent magnet 32 and an electromagnet 36, wherein the permanent magnet 32 projects from the periphery of the lens 12 while the electromagnet 36 is disposed on the casing of the digital still camera 10. When the electromagnetic switch turns on, the permanent magnet 32 and the electromagnet 36 will produce a magnetic force driving lens 12 to rotate relative to the digital still camera 10. Further, the electromagnetic switch includes switching element 34, which is coupled to electromagnet 36 for converting the polarity thereof.

The electromagnet as shown in FIG. 3A to 3B includes an iron rod 364, coils 362 and 364, and a power source 368. The iron rod 364, which is illustrated by example of a straight iron bar, has a first end 364a and a second end 364b with coils 362 and 364 winding around iron bar 364. The power source 368 provides current I to the coil 362 or coil 366 and forms a first magnetic pole and a second magnetic pole at the first end 364a and the second end 364b respectively. The switching element 34 is for switching the flow path of the current so as to change the polarity of the electromagnet 36 and redefine the polarity thereof.

In FIG. 3A, current I flows from the first end 364a to the second end 364b in a clockwise direction via the coil 362. Therefore, an S-polarity is formed at the first end 364a and is defined as the first magnetic pole, while an N-polarity is formed at the second end 364b and is defined as the second magnetic pole. As shown in FIG. 3A, since the permanent magnet 32 projects its N-polarity end on the periphery of the lens 12, a mutual attraction produced by two opposite polarities, i.e. the N-polarity of the permanent magnet 32 and the S-polarity of the first end 364a of the iron rod 364, will drive the permanent magnet 32 to rotate towards the first end 364a. On the contrary, if the permanent magnet 32 projects its S-polarity end on the periphery of the lens 12, a mutual attraction produced by two opposite polarities, i.e. the S-polarity of permanent magnet 32 and the N-polarity of the second end 364b of the iron rod 364, will drive the permanent magnet 32 to rotate towards the second end 364b.

In the second preferred embodiment, the lens control apparatus adopts a dual-coil-single-power module. The power source 368 is a single set, but the coils 362 and 366 are a dual-coil set winding around the iron rod 364 in opposite directions, providing the current with two flow paths of opposite directions. The switching element is for changing the flow path of the current so that the polarity of the electromagnet can be re-defined. In FIG. 3B, the switching element 34 switches the flow path of the current, causing the current to flow anti-clockwise from the first end 364a to the second end 364b. An N-polarity is formed at the first end 364a and is defined as the second magnetic pole, while an S-polarity is formed at the second end 364b and is defined as the first magnetic pole. Since the permanent magnet 32 projects its N-polarity end on the periphery of the lens 12, the mutual attraction produced by the N-polarity of the permanent magnet 32 and the S-polarity of the second end 364b will drive the lens 12 to rotate towards the second end 364b. On the contrary, if the permanent magnet 32 projects its S-polarity end on the periphery of the lens 12, the mutual attraction produced by the S-polarity of the permanent magnet 32 and the N-polarity of the first end 364a will drive the lens 12 to rotate towards the first end 364a.

The lens control apparatus according the second preferred embodiment controls both the direction of the current and the flow path of the current by switching a dual-coil set to form an electromagnetic switch with two opposite polarities. The permanent magnet 32 can then either drive the lens 12 to rotate β1 degrees relative to the digital still camera to be positioned at the first end 364a or drive the lens 12 to rotate β2 degrees relative to the digital still camera to be positioned at the second end 364b, so that the lens 12 can be zoomed in or zoomed out to adjust the focal length. A two-level zooming is thus achieved accordingly.

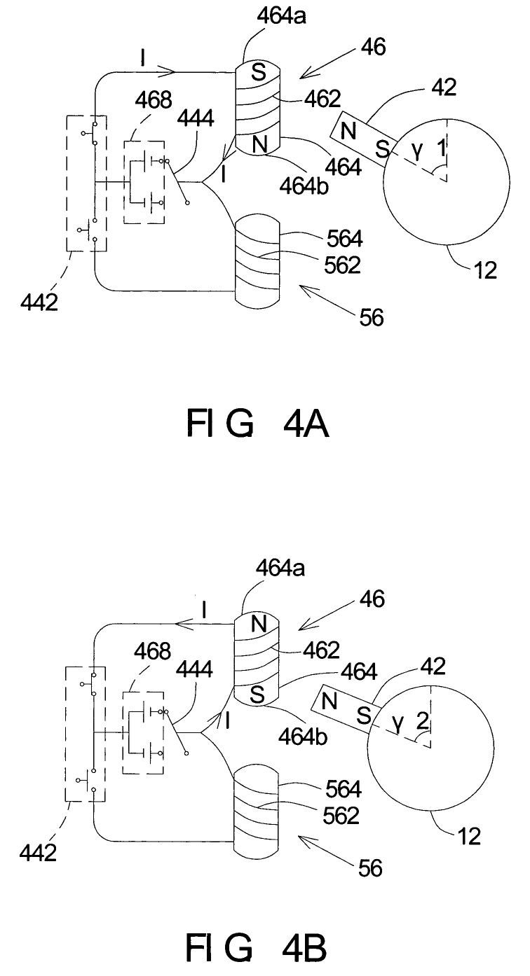

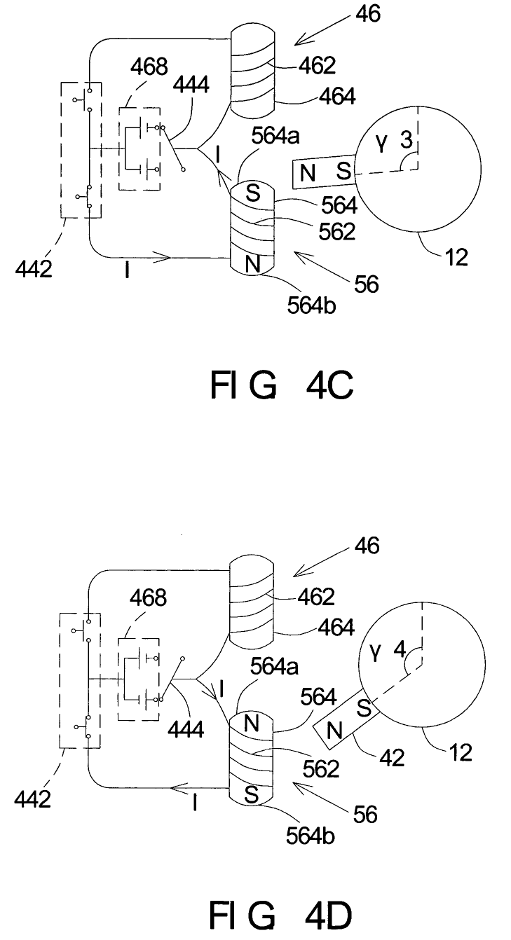

FIGS. 4A to 4D show the movements of the lens control apparatus of a digital still camera according to a third embodiment of the invention. The electromagnetic switch of the lens control apparatus as shown in FIG. 4A to FIG. 4D includes a permanent magnet 42, a first electromagnet 46 and a second electromagnet 56. The permanent magnet 42 projects from the periphery of the lens 12 while the first electromagnet 46 and the second electromagnet 56 are disposed on the casing of the digital still camera 10 but are positioned at different angles to the lens 12. The electromagnetic switch includes a power source 468; thereby the electromagnetic switch can be turned on. When the electromagnetic switch turns on, the permanent magnet 42 and either one of the first electromagnet 46 and the second electromagnet 56 will produce a magnetic force driving lens 12 to rotate to different angles relative to the digital still camera 10.

As shown in FIG. 4A to FIG. 4D, the first electromagnet 46 includes a first iron rod 464 and a first coil 462. The first iron rod 464 has a first end 464a and a second end 464b with the first coil 462 winding around the first iron rod 464. The power source provides the first coil 462 with current defining a first magnetic pole and a second magnetic pole at the first end 464a and the second end 464b respectively. The second electromagnet 56 includes a second iron rod 564 and a second coil 562. The second iron rod 564 has a third end 564a and a fourth end 564b with the second coil 562 winding around the second iron rod 564. The power source provides the second coil 562 with current defining a third magnetic pole and a fourth magnetic pole at the third end 564a and the fourth end 564b respectively.

The electromagnetic switch includes a coil switching element 442 coupled to the first electromagnet 46 and the second electromagnet 56 for switching the first coil 462 and the second coil 562 and selecting either one of the two coils as the flow path of the current so that a magnetic force can be created between the permanent magnet 42 and either one of the first electromagnet 46 and the second electromagnet 56. As shown in FIG. 4A, when the electromagnetic switch turns on, the first coil 462 is selected by the coil switching element 442 as the flow path, while the mutual attraction produced by the first end 464a of the first iron rod 464 and the permanent magnet 42 due to their opposite polarities makes the permanent magnet 42 drive the lens 12 to rotate towards the first end 464a. As shown in FIG. 4C, when the electromagnetic switch turns on, the second coil 562 is selected by the coil switching element 442 as the flow path, while the mutual attraction produced by the third end 564a of the second iron rod 564 and the permanent magnet 42 due to their opposite polarities makes the permanent magnet 42 drive the lens 12 to rotate towards the third end 564a.

As shown in FIG. 4A to FIG. 4D, the power source can be a dual power set 468 providing two currents of opposite directions. The electromagnetic switch includes a power switching element 444, which is coupled to the first electromagnet 46 and the second electromagnet 56, for switching the direction of the current so that the polarity of the first electromagnet 46 or the second electromagnet 56 can be re-defined.

FIG. 4A and FIG. 4B show the process of changing the polarity of the first electromagnet 46 via the power switching element 444. In FIG. 4A, current I flows from the first end 464a to the second end 464b in a clockwise direction via the coil 462. Therefore, an S-polarity is formed at the first end 464a and is defined as the first magnetic pole, while an N-polarity is formed at the second end 464b and is defined as the second magnetic pole. As shown in FIG. 4A, since the permanent magnet 42 projects its N-polarity end on the periphery of the lens 12, a mutual attraction produced by two opposite polarities, i.e. the N-polarity of the permanent magnet 42 and the S-polarity of the first end 464a of the iron rod 464, will drive the lens 12 to rotate towards the first end 464a. In FIG. 4B, when the power switching element 444 switches the direction of the current causing the current to flow from the second end 464b to the first end 464a in an anti-clockwise direction via the coil 462, the polarity of the first electromagnet 46 will be changed accordingly. An N-polarity is formed at the first end 464a and defined as the second magnetic pole, while an S-polarity is formed at the second end 464b and is defined as the first magnetic pole. Since the polarity of the permanent magnet 42 is opposite to that of the second end 464b of the first iron rod 464, a mutual attraction produced by their opposite polarities will drive the lens 12 to rotate towards the second end 464b.

FIG. 4C and FIG. 4D show the process of changing the polarity of the second electromagnet 56 via the power switching element 444. In FIG. 4C, current I flows from the fourth end 564b to the third end 564a in a clockwise direction via the coil 562. Therefore, an S-polarity is formed at the third end 564a and is defined as the third magnetic pole, while an N-polarity is formed at the fourth end 564b and is defined as the fourth magnetic pole. As shown in FIG. 4C, since the permanent magnet 42 projects its N-polarity end on the periphery of the lens 12, a mutual attraction produced by two opposite polarities, i.e. the N-polarity of permanent magnet 42 and the S-polarity of the third end 564a of the iron rod 564, will drive the lens 12 to rotate towards the third end 564a. In FIG. 4D, when the power switching element 444 switches the direction of the current causing the current to flow from the third end 564a to the fourth end 564b in an anti-clockwise direction via the coil 562, the polarity of the second electromagnet 56 will be changed. An N-polarity is formed at the third end 564a and defined as the fourth magnetic pole, while an S-polarity is formed at the fourth end 564b and is defined as the third magnetic pole. Since the polarity of the permanent magnet 42 is opposite to that of the fourth end 564b of the first iron rod 564, a mutual attraction produced by their opposite polarities will drive the lens 12 to rotate towards the fourth end 564b.

The lens control apparatus according the third embodiment, which adopts a dual-coil-dual-power module using more than two electromagnets, is used in association with the coil switching element 442 and the power switching element 444. By switching the direction of the current and the flow path of the current, the electromagnetic switches with different polarities and different angles can be formed. The permanent magnet 42 can then either drive the lens 12 to rotate ?1 degrees relative to the digital still camera 10 to be positioned at the first end 464a, or drive the lens 12 to rotate ?2 degrees to be positioned at the second end 464b, or drive the lens 12 to rotate ?3 degrees to be positioned at the third end 564a, or drive the lens 12 to rotate ?4 degrees to be positioned at the fourth end 564b. By rotating the lens to be positioned at different angles, the lens 12 can be zoomed in or zoomed out to achieve desired focal lengths. A multi-level zooming function of the digital still camera is thus achieved.

The switching element in the first and the second embodiments as well as the coil switching element and the power switching element in the third embodiment can be associated with a button or a switch to facilitate and simplify the operation of the electromagnetic switch. The above mechanism is simpler when compared with a pure mechanic design; furthermore, the design according to the invention has dispensed with the use of a motor, hence a smaller space would suffice the need.

Furthermore, the lens control apparatus according to the invention includes a torsion spring disposed in the lens. When the electromagnetic switch fails to turn on, the current can not be generated. Consequently, the electromagnet will lose its magnetism and no mutual attraction can be produced between the permanent magnet and the electromagnet. Under such circumstances, the torsion spring will drive the lens to rotate and turn for homing.

The lens control apparatus of the digital still camera according to the invention disclosed in the above embodiments uses the magnetism produced by the electromagnetic switch to power the rotation of the lens without resorting to manual operation or the use of a motor. By means of a simple design of the mechanism, the lens can be easily driven to rotate so that its zooming function can be actuated accordingly. Meanwhile, the invention can adopt a multi-electromagnet design which drives the lens to rotate to different positions and different angles, so that the lens can be zoomed in or zoomed out to achieve different focal lengths. A multi-level zooming control is thus achieved.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A lens control apparatus, comprising:
a lens rotatably coupled to a casing; and
an electromagnetic switch, including
a permanent magnet disposed onto a peripheral of the lens; and
an electromagnet disposed at one side of the casing closer to the lens;
wherein when the electromagnet switch turns on, a magnetic force produced by the permanent magnet and the electromagnet drives the lens to rotate relative to the casing.

2. The lens control apparatus according to claim 1, wherein the electromagnetic switch comprises a switching element coupled to the electromagnet for converting a polarity thereof.

3. The lens control apparatus according to claim 2, wherein the electromagnet comprises:
an iron rod which has a first end and a second end;
a coil which winds around the iron rod; and
a power source which provides current to the coil and forms a first magnetic pole at the first end and a second magnetic pole at the second end;
wherein a mutual attraction produced by the permanent magnet and the first end of the iron rod due to their opposite polarities makes the permanent magnet drive the lens to rotate towards the first end.

4. The lens control apparatus according to claim 3, wherein when the switching element converts the polarity of the electromagnet so as to define the first end as the second magnetic pole and the second end as the first magnetic pole, a mutual attraction produced by the permanent magnet and the second end of the iron rod due to their opposite polarities makes the permanent magnet drive the lens to rotate towards the second end.

5. The lens control apparatus according to claim 3, wherein the power source is a dual power set providing the coil with two currents of opposite directions, and wherein the switching element is for converting the direction of the current so that the polarity of the electromagnet is re-defined.

6. The lens control apparatus according to claim 5, wherein the coil is a single coil set.

7. The lens control apparatus according to claim 3, wherein the coil is a dual coil set winding around the iron rod in opposite directions, providing the current with two flow paths of the opposite directions, and wherein the switching element is for converting the flow paths so that the polarity of the electromagnet is re-defined.

8. The lens control apparatus according to claim 7, wherein the power source is a single power set.

9. The lens control apparatus according to claim 1, wherein the apparatus further comprises a torsion spring which is disposed at the lens and drives the lens to rotate and turn for homing when the electromagnetic switch fails to turn on so that the electromagnet loses its magnetism.

10. A lens control apparatus, comprising:
a lens rotatably coupled to a casing; and
an electromagnetic switch, including
a permanent magnet projecting from a peripheral of the lens;
a first electromagnet disposed at the casing; and
a second electromagnet disposed at the casing, wherein the second and first electromagnets disposed at the same side of the lens are positioned at different angles to the lens;
wherein when the electromagnet switch turns on, a magnetic force produced by the permanent magnet and either one of the first and the second electromagnets drives the lens to rotate to different angles relative to the casing.

11. The lens control apparatus according to claim 10, wherein the electromagnetic switch comprises a power source.

12. The lens control apparatus according to claim 11, wherein the first electromagnet comprises:
a first iron rod, which has a first end and a second end; and
a first coil which winds around the iron rod, wherein the power source provides current to the first coil, defining a first magnetic pole and a second magnetic pole at the first end and the second end respectively;
wherein the mutual attraction produced by the permanent magnet and the first end of the first iron rod due to their opposite polarities makes the permanent magnet drive the lens to rotate towards the first end.

13. The lens control apparatus according to claim 12, wherein the second electromagnet comprises:
a second iron rod, which has a third end and a fourth end; and
a second coil which winds around the second iron rod, wherein the power source provides current to the second coil, defining a third magnetic pole and a fourth magnetic pole at the third end and the fourth end respectively;
wherein the mutual attraction produced by the permanent magnet and the third end of the second iron rod due to their opposite polarities makes the permanent magnet drive the lens to rotate towards the third end.

14. The lens control apparatus according to claim 13, wherein the electromagnetic switch comprises:
a coil switching element, which is coupled to the first and the second electromagnets, for switching the first and the second coils and selecting one of the two coils as the flow path of the current so that a magnetic force can be produced by the permanent magnet and either one of the first and the second electromagnets.

15. The lens control apparatus according to claim 13, wherein the power source is a dual power set providing two currents of opposite directions and the electromagnetic switch further comprises:
a power switching element coupled to the first and the second electromagnets for switching the direction of the current so that the polarity of the first or the second electromagnet can be re-defined.

16. The lens control apparatus according to claim 15, wherein a mutual attraction produced by the permanent magnet and the second end of the first iron rod due to their opposite polarities makes the permanent magnet drive the lens to rotate towards the second end when the power switching element switches the direction of the current, converts the polarity of the first electromagnet, and defines the first end as the second magnetic pole and the second end as the first magnetic pole.

17. The lens control apparatus according to claim 15, wherein a mutual attraction produced by the permanent magnet and the fourth end of the second iron rod due to their opposite polarities makes the permanent magnet drive the lens to rotate towards the fourth end when the power switching element switches the direction of the current, converts the polarity of the first electromagnet, and defines the third end as the fourth magnetic pole and the fourth end as the third magnetic pole.
